(19) United States
(12) Patent Application Publication
(10) Pub. No.: US 2016/0042584 A1
(43) Pub. Date: Feb. 11, 2016

(54) APPARATUS AND METHOD FOR DISPENSING AND RECEIVING MEDICAL SELF-COLLECTION DEVICES

(71) Applicant: Stacey Golub, Kansas City, MO (US)

(72) Inventor: Stacey Golub, Kansas City, MO (US)

(21) Appl. No.: 14/822,546

(22) Filed: Aug. 10, 2015

Related U.S. Application Data
(60) Provisional application No. 62/035,257, filed on Aug. 8, 2014.

(51) Int. Cl. G07F 11/00; G07F 17/00; A61J 1/00

(52) U.S. Cl. CPC G07F 11/00; A61J 1/00; G07F 17/0092

(57) ABSTRACT

The invention provides an apparatus for dispensing and otherwise facilitating the self-collection of biological medical samples. The apparatus is configured to dispense a medical self-collection device to a user and to hold or store a used medical self-collection device that has been deposited into the apparatus by a user for laboratory analysis.

### RELATED APPLICATIONS

This application claims priority from U.S. Provisional Patent Application Ser. No. 62/035257 filed Aug. 8, 2014, which application is incorporated herein by reference in its entirety.

### FIELD OF THE INVENTION

The present invention relates to a novel apparatus suitable for dispensing and receiving medical self-collection devices to obtain analysis of routine biological samples from a user and a method for dispensing and receiving medical self-collection devices from a dispensing apparatus. The apparatus and method enables users to quickly and conveniently submit a biological sample for analysis and obtain results without the need for a traditional medical office or laboratory visit.

### BACKGROUND OF THE INVENTION

Currently, patients may suffer from a wide-range of diseases that require doctor visits and extensive testing to diagnose, treat and/or cure. Many illnesses and infections can be treated and/or cured if diagnosed early, while other diseases need periodic testing to keep the disease regulated; however, many patients are unable to obtain the testing they need for early diagnosis. Long waiting periods for doctor appointments, having a demanding schedule and/or limited time during clinic business hours, limited access to a doctor's office, the tedious and time-consuming nature of paperwork and patient updates for doctor's visits, not being able to afford doctor's visits and/or having limited doctor visits due to insurance restrictions, not having an address and/or insurance to cover doctor's visits, and the need for privacy or anonymity with regard to a condition often results in patients refraining from getting the laboratory testing they need.

The delay in getting necessary diagnostic testing results in increased transmission of diseases, complications with pregnancies, a reduction in testing sensitivity and specificity (in cases such as an STD sore healing before being swabbed and tested), fewer patients getting treatment and more patients becoming critically ill—thus resulting in more emergency room/hospital use and/or stays—and, in worse cases, an increase in patient suffering and death. In many cases, the tests for these diseases could be self-collected and would not require doctor visits. Self-collection could also serve to eliminate common errors such as mislabeling, improper collection, improper storage and/or transport of collection devices, among others. Enabling patients needing immediate testing to follow self-collection instructions, label and select the exact testing needed (as determined by the patient or advised by a doctor), and self-collect their samples as dictated by their schedule and location would remove some of these barriers to laboratory testing and provide greater access to care.

Thus, there is a need in the art for an apparatus and system to facilitate self-collection of medical samples. Such an apparatus may be conveniently placed to provide 24-hour access to users for obtaining and receiving medical self-collecting devices. The used medical self-collecting devices are stored in the apparatus until they are removed by authorized personnel and transported to a laboratory for analysis.

### SUMMARY OF THE INVENTION

The purpose of the present invention is to provide a dispensing and collection apparatus for medical self-collection devices and a method for dispensing and receiving medical self-collection devices to or from a user. The apparatus generally comprises at least one inner compartment that includes at least one dispensing reservoir and at least one collection reservoir, a user interface in communication with the at least one dispensing reservoir and at least one collection reservoir and configured to accept personal information inputed by a user, a payment collection unit in communication with the user interface and is configured to collect payment from the user, and at least one receptacle configured for holding a dispensed medical self-collection device or receiving a used medical self-collection device. The dispensing reservoir is preferably configured to store or hold unused medical self-collection devices until dispensed to a user and the at least one collection reservoir is preferably configured to store or hold used medical self-collection devices which have been returned by a user.

The present disclosure further provides a method for dispensing and receiving medical self-collection devices from an apparatus, the system comprising: receiving personal information from a user through a user interface located on an apparatus; dispensing an unused medical self-collection device from at least one dispensing reservoir located within at least one inner compartment of the apparatus into a receptacle; receiving a used medical self-collection device from the user; storing the used medical self-collection device in at least one collection reservoir located within the at least one inner compartment of the apparatus; and removing the used medical self-collection device from the collection reservoir for laboratory analysis.

### BRIEF DESCRIPTION OF DRAWINGS

FIG. 1 is a front perspective view of a first embodiment of the apparatus.

FIG. 2 is a front view of a second embodiment of the apparatus.

FIG. 3 is a side view of the apparatus.

### DETAILED DESCRIPTION OF THE INVENTION

The present disclosure generally provides a dispensing and collection apparatus for medical self-collection devices and a method for dispensing and receiving a medical self-collection device to or from a user. The apparatus and method provide novel ways to facilitate laboratory testing for users without the need for a traditional doctor or laboratory visit.

### (I) Apparatus

A first aspect of the present disclosure provides a dispensing and collection apparatus for medical self-collection devices. The medical self-collection device may be any device that securely holds a medical sample. Examples of the medical self-collection devices able to be used in the present invention include universal swab media such as a Remel® Universal M4 swab or a urine collection device. Preferably, the universal swab media is any media which is capable of maintaining a wide variety of biological samples until the samples can be analyzed by a laboratory.

The apparatus is comprised of a housing with front, rear, top, bottom and side panels. Those skilled in the art will appreciate that the housing can be constructed from a variety of suitable materials and with a variety of suitable manufacturing techniques. One of skill in the art will also appreciate that any size apparatus will be possible depending on where the apparatus is to be placed for easy access by users.

The housing preferably completely surrounds the inner compartment of the apparatus. The inner compartment is configured to house at least one dispensing reservoir and at least one collection reservoir. The dispensing reservoir holds and provides means for dispensing unused medical self-collection devices as requested by a user. The collection reservoir holds or stores used medical self-collection devices deposited or returned by a user and which contain a biological sample for testing. The dispensing reservoir and collection reservoir are preferably removable from the apparatus through a secured opening positioned on the housing of the apparatus, which secured opening provides authorized access to the inner compartment. In one embodiment, the dispensing reservoir and collection reservoir are completely removable from the inner compartment, for example, to restock or refill an empty or partially empty dispensing reservoir or empty a full or partially full collection reservoir. Removal of an entire reservoir facilitates easy access to the used or unused medical self-collection devices stored within the apparatus. In an alternative embodiment, the reservoirs are not removable and are securely positioned within the apparatus to permit easy access by authorized personnel to refill or empty the reservoirs.

The collection reservoir may be configured to appropriately maintain the biological sample deposited in the used medical self-collection device until laboratory analysis, for example, by providing refrigeration or freezing means within the collection reservoir. In some embodiments, samples are storable under ambient conditions and no heating or cooling devices are needed for maintaining the sample. One of skill in the art will appreciate that collection reservoir may be equipped with appropriate storage means depending on the type of used medical device deposited by the user. In a first embodiment, the apparatus may include multiple collection reservoirs depending on the storage means required for the type of sample provided. For instance, blood samples returned in a used medical self-collection device may need to be stored in a cooled collection reservoir while urine samples are stored in a separate collection reservoir that is not cooled. In another embodiment, the apparatus contains a single collection reservoir that is held at a constant temperature regardless of the type of sample returned in a used medical self-collection device.

The apparatus also may comprise at least one input/output opening on the housing, the input/output openings being operatively connected to the reservoir and collection receptacle and configured to hold an unused medical self-collection device dispensed to the user from the reservoir or a used device returned by a user. In an alternative embodiment, there may be two input/output openings located on the housing of the apparatus, one for holding an an unused medical self-collection device from the reservoir, and one for holding a used medical self-collection device deposited by a user and returned to the apparatus's collection receptacle.

A user interface is also positioned on the housing of the apparatus and is configured to accept personal information from a user. For purposes of this invention, users include, but are not limited to, patients and/or their guardians. The user interface is configured to accept personal information from a user including but not limited to, identification information such as name and address, insurance information, information regarding previous treatment and symptoms, and the like. In some embodiments, a user may optionally create an account through the user interface which is then accessible from other apparatuses and/or from an internet website. The user account is preferably secured with a password or other security measures such as data encryption. The user account may, in some embodiments, allow the user to select a preference for delivery of results of the testing to be conducted on the sample collected in the medical self-collection device. One of skill in the art will appreciate that delivery may be by phone, email, mail, at the user interface, or any other method known in the art.

In one embodiment, the user interface may be configured to solicit answers to basic medical questions through various prompts programmed into the user interface. Such prompts, in some instances, may direct the apparatus to dispense a particular type of medical self-collection device dispensed to the user from the reservoirs. In other embodiments, the prompts may give information about over-the-counter products that may be used to assist with the types of symptoms inputed by the user. In still other embodiments, the prompts may give basic information about a medical condition. The user interface may also be configured to provide instructions for using the apparatus or for using the medical self-collection device, via the interface.

The user interface is optionally connected to one or more printers which are housed within the apparatus. The printers may be used to provide a printed receipt for payment. The printer may also be used to provide instructions for self-collection and use of the medical self-collection device. In some embodiments, the printer may provide information about a medical condition. In still other embodiments, the printer may be used to provide advertisements and coupons.

The apparatus may also include a payment collection unit in communication with the user interface. The payment collection unit is configured to collect payment from the user. Such configuration may include, for example, acceptance of cash or a credit or debit card reader. Information regarding collection of payment is preferably associated with user information imputed on the user interface. In one embodiment, payment may be divided between an initial payment made upon the user's receipt of the medical self-collection device. In such embodiments, a second payment is required when the used medical self-collection device is returned to the apparatus.

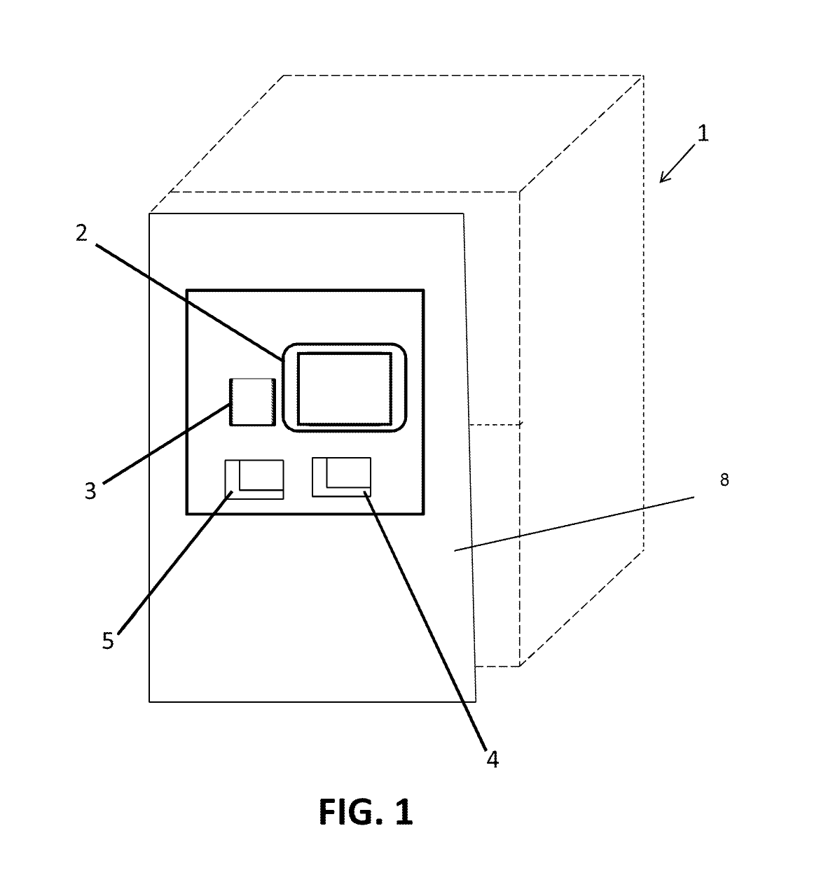

Referring now to the figures, FIG. 1 illustrates one embodiment of the front panel of the apparatus generally designated 1. The apparatus may be a kiosk or other type of structure capable of dispensing and receiving devices to/from a user. The apparatus 1 includes a housing 8 having a front, rear, top, bottom and side panels. The side panel of the housing preferably contains one or more secured openings permitting access by authorized personnel to the at least one inner compartment for stocking of unused medical self-collection devices and/or for collection of used medical self-collection devices (openings in the 1 side panels are not pictured). The openings may be hinged, sliding or revolving and are preferably locked.

The apparatus 1 further includes a user interface 2 configured to accept and store data inputed by a user. The user interface 2 may be any interface capable of accepting information from a user, for example, a touch-activated display screen or a keypad.

The apparatus 1 is also configured to provide a requested medical self-collection device to a user following the input of information from the user into the user interface by way of an input/output opening 4 on the housing and to allow deposit of a medical self-collection device into the dispensing machine through an opening 5. In some embodiments, information inputed to the user interface may be used to create a label which is either affixed to the outside of the medical self-collection device by a mechanism within the apparatus or is printed for the user to affix the label to the outside of the medical self-collection device. The user interface 2 may be configured for communication with a payment collection unit 3.

The user interface 2 permits consumers and/or inventory stocking personnel to communicate with the apparatus 1 and/or a network or website linked in electrical communication with the dispensing apparatus 1. The user interface 2 also permits consumers and/or inventory stocking personnel to enter appropriate commands directed to carrying out specific machine tasks.

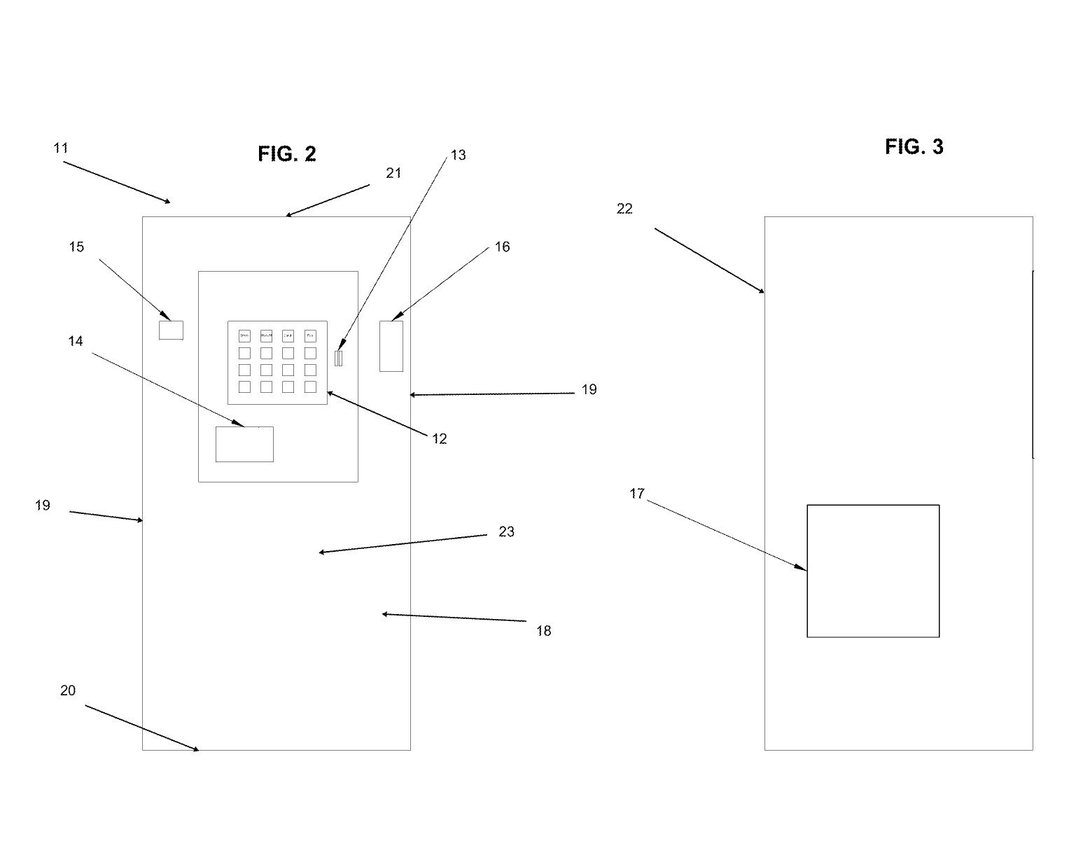

FIG. 2 illustrates an additional embodiment of the dispensing apparatus generally designated 11. The apparatus may be a kiosk or other type of structure capable of dispensing and receiving devices to/from a user. The apparatus 11 includes a housing 18 having a front 23, rear 22, top 21, bottom 20 and side panels 19. The illustrated side panel of the housing preferably contains one or more secured openings permitting access by authorized personnel to the at least one inner compartment for stocking of unused medical self-collection devices and/or for collection of used medical self-collection devices. The openings may be hinged, sliding or revolving and are preferably locked.

The apparatus 11 further includes a user interface 12 configured to accept and store data inputed by a user. The user interface 12 may be any interface capable of accepting information from a user, for example, a touch-activated display screen or a keypad.

The apparatus 11 is also configured to provide a requested medical self-collection device to a user following the input of information from the user into the user interface by way of an input/output opening 14 on the housing and to allow deposit of a medical self-collection device into the dispensing machine through the same opening 14. In some embodiments the input/output opening is covered (covering not pictured). In some embodiments, information inputed to the user interface may be used to create a label which is either affixed to the outside of the medical self-collection device by a mechanism within the apparatus or is printed for the user to affix the label to the outside of the medical self-collection device. The user interface 12 may be configured for communication with a payment collection unit 13.

The apparatus 11 further includes a sanitizer 15. The sanitizer 15 contains one or more chemicals for hand sanitization. The sanitizer 15 is configured to dispense hand sanitizer. In a preferred embodiment the sanitizer 15 dispenses sanitizer when a user's hand is placed under the sanitizer 15. It is also contemplated that the sanitizer 15 dispenses the sanitizer by the user pumping the sanitizer.

The apparatus 11 may further include a bag dispenser 16. In one embodiment the bag dispenser 16 may be affixed to the front surface of the apparatus 11. In another embodiment the bag dispenser 16 is attached to a side surface of the apparatus 11. The bag dispenser 16 holds bags, or other containers for holding medical self-collection devices once the medical self-collection device has been dispensed.

The user interface 12 permits consumers and/or inventory stocking personnel to communicate with the apparatus 11 and/or a network or website linked in electrical communication with the dispensing machine. The user interface 12 also permits consumers and/or inventory stocking personnel to enter appropriate commands directed to carrying out specific machine tasks.

FIG. 3 is a side view of the apparatus 11. The apparatus 11 further includes a storage 17. The storage 17 may be configured to hold unused medical self-collection devices until they are dispensed. It is further contemplated that the storage 17 may be configured to hold used medical self-collection devices until the used self-collection devices are sent to a lab for analysis.

### (II) System for Dispensing and Receiving Medical Self-Collection Devices

The present disclosure also provides a system for dispensing and receiving medical self-collection devices from an apparatus, the system comprising: receiving personal information from a user through a user interface located on a housing of the apparatus; receiving payment from the user using a payment collection unit in communication with the user interface; dispensing an unused medical self-collection device from at least one reservoir located in at least one inner compartment within the apparatus to the user through a covered output opening on the housing of the apparatus; and receiving a used medical self-collection device from a user, the used device received into at least one collection receptacle located within the inner compartment of the apparatus through a covered input opening on the housing of the apparatus; wherein the used medical self-collection device is associated or labeled with the personal information entered by the user through the user interface; and storing the used medical self-collection device; and removing the stored used medical self-collection device from the apparatus for analysis by a laboratory.

In another aspect, the present invention provides a method for providing remote assessment of a medical sample. The method comprises providing a user with an apparatus as described in Section I. The apparatus is configured to dispense a medical self-collection device and to provide the user with information about self-collection of the medical sample. As described above, the apparatus is configured to accept the used medical self-collection device and hold the used medical self-collection device until it is removed by authorized personal for delivery to a remote site for laboratory analysis. A variety of tests may be conducted on the sample. In some embodiments, the type of testing is determined by the information that the user provides to the user interface. In other embodiments, a range of laboratory testing is provided. Laboratory testing may be directed to diseases such as sexually transmitted diseases, infections, respiratory viruses and the like. Examples of specific diseases that may be detected include Chlamydia trachomatis (CT) and Neisseria Gonorrhea (NG), and Trichomoniasis (TV); H1N1/Respiratory Viruses such as Influenza, Parainfluenza, Respiratory Syncytial Virus (RSV), Rhinovirus, and Metapneumovirus, Adenovirus; Bacterial Vaginosis (BV); Vaginal Candidiasis; Human Papilloma Virus (HPV); and Herpes Virus (HSV), among many others.

The user information tagged to the medical-self collection device may be used to report the results of the laboratory analysis. The results of the laboratory analysis can then be provided to the user and/or the patient's doctor. Preferably, results of the laboratory analysis are provided to the patient by a method selected by the patient. For example, the patient may elect to receive a letter, phone call, e-mail, or may elect to return to the apparatus to obtain the results in a secure manner.

Those skilled in the art will appreciate that variations from the specific embodiments disclosed above are contemplated by the invention. The invention should not be restricted to the above embodiments, but should be measured by the following claims.

What is claimed is:

1. An apparatus for dispensing and receiving a medical self-collection device, the apparatus comprising:
an inner compartment;
a housing surrounding the inner compartment;
a user interface positioned on the housing and configured to accept information from a user;
a means of dispensing the medical self-collection device; and
a means of receiving a used medical self-collection device.

2. The apparatus of claim 1 further comprising payment collection unit in communication with the user interface and configured to collect payment from the user.

3. The apparatus of claim 1 further comprising a reservoir located within the inner compartment for holding unused medical self-collection devices.

4. The apparatus of claim 1 further comprising a covered output opening positioned on the housing and being operatively connected to the reservoir and configured to dispense an unused medical self-collection device to the user.

5. The apparatus of claim 1 further comprising a covered input opening for accepting a used medical self-collection device from the user.

6. The apparatus of claim 1 further comprising a collection receptacle located within the inner compartment being operatively connected to the covered input opening for holding used medical self-collection devices.

7. The apparatus of claim 6 wherein the used medical self-collection device is labeled with the information entered by the user on the user interface.

8. The apparatus of claim 3 wherein there is a means for adjusting the temperature in the reservoir.

9. The apparatus of claim 6 wherein there is a means for adjusting the temperature in the collection receptacle.

10. An apparatus for dispensing and receiving a medical self-collection device, the apparatus comprising:
an inner compartment;
a housing surrounding the inner compartment;
a user interface positioned on the housing and configured to accept information from a user;
a payment collection unit in communication with the user interface and configured to collect payment from the user;
a reservoir located within the inner compartment for holding unused medical self-collection devices;
a covered output opening positioned on the housing and being operatively connected to the reservoir and configured to dispense an unused medical self-collection device to the user;
a covered input opening for accepting a used medical self-collection device from the user; and
a collection receptacle located within the inner compartment being operatively connected to the covered input opening for holding used medical self-collection devices,
wherein the used medical self-collection device is labeled with the information entered by the user on the user interface.

11. A method for dispensing and collecting a medical self-collection device from an apparatus, the method comprising:
receiving information from a user;
dispensing an unused medical self-collection device from a reservoir; and
accepting a used medical self-collection device into a collection receptacle.

12. The method of claim 11 wherein the apparatus receives information by means of a user interface positioned on a housing of the apparatus.

13. The method of claim 11 wherein a payment is received from the user using a payment collection unit in communication with the user interface after the apparatus receives user information.

14. The method of claim 11 wherein the reservoir is located within an inner compartment of the apparatus and the unused medical self-collection device is dispensed to the user through a covered output opening positioned on the housing of the apparatus.

15. The method of claim 11 wherein the collection receptacle is located within the inner compartment of the apparatus and the used medical self-collection device is accepted from the user through a covered input opening positioned on the housing of the apparatus.

16. The method of claim 11 wherein the used medical self-collection device is labeled with the information entered by the user on the user interface.

17. The method of claim 11 wherein the used medical self-collection device is accepted through the same opening that the unused medical self-collection device is dispensed.

18. The method of claim 11 wherein the used medical self-collection device is held in a storage until an authorized personnel collects the used medical self-collection devices.

19. The method of claim 11 wherein after the used medical self-collection devices are collected, the used medical self-collection devices are analyzed.

20. The method of claim 19 wherein the results of the analysis are relayed to the user.
